(19) United States
(12) Patent Application Publication
(10) Pub. No.: US 2018/0174491 A1
(43) Pub. Date: Jun. 21, 2018

(54) APPARATUS FOR MINIMALLY INVASIVE PERCUSCOPIC SURGICAL SIMULATION

(71) Applicant: LSI Solutions, Inc., Victor, NY (US)

(72) Inventor: Jude S. Sauer, Pittsford, NY (US)

(21) Appl. No.: 15/847,614

(22) Filed: Dec. 19, 2017

Related U.S. Application Data
(60) Provisional application No. 62/436,330, filed on Dec. 19, 2016.

(51) Int. Cl. G09B 23/34; G09B 9/00; G02B 23/24

(52) U.S. Cl. CPC G09B 23/34; G02B 23/2484; G09B 9/00

(57) ABSTRACT

An apparatus for surgical simulation has a main storage compartment having a pivoting lid, a lid liner defining a display opening, and a light source. The apparatus also has an external support assembly removably coupled to the storage compartment in a stowed configuration and further configured to provide a support structure for the storage compartment in an unstowed configuration. The apparatus further has a removable platen configured to be held by the main storage compartment in either a stowed position or a display position. The apparatus also has a ribcage coupled to the removable platen. The apparatus also has a rail system for holding an anatomical model within the rib cage. The apparatus further has a computer display for viewing through the display opening. The apparatus also has a camera on a flexible support, coupled to the computer display and configured to display video or images of the anatomical model.

### RELATED APPLICATION

This patent application claims priority to U.S. Provisional Patent Application No. 62/436,330 filed Dec. 19, 2016 and entitled “APPARATUS FOR MINIMALLY INVASIVE PERCUSCOPIC SURGICAL SIMULATION”. The 62/436,330 application is hereby incorporated by reference in its entirety.

### FIELD

The claimed invention relates to surgical training simulators for minimally invasive surgical procedures, and more specifically for minimally invasive cardiac procedures.

### BACKGROUND

Mastering a complex surgical procedure typically requires extensive training. Developing the techniques and skills for minimally invasive cardiac surgical procedures such as minimally invasive aortic valve replacement (MI-AVR), minimally invasive mitral valve replacement (MI-MVR), or minimally invasive mitral valve repair (MI-MVrepair) can be prohibitively inconvenient for busy cardiac surgeons. There is a need for a self-contained comprehensive training simulator platform to help optimize the use of time for both surgeons and their staff, while enabling technique refinement outside of the clinical setting.

### SUMMARY

An apparatus for surgical simulation has a main storage compartment having a pivoting lid, a lid liner defining a display opening, and a light source. The apparatus also has an external support assembly removably coupled to the storage compartment in a stowed configuration and further configured to provide a support structure for the storage compartment in an unstowed configuration. The apparatus further has a removable platen configured to be held by the main storage compartment in either a stowed position or a display position. The apparatus also has a ribcage coupled to the removable platen. The apparatus also has a rail system for holding an anatomical model within the rib cage. The apparatus further has a computer display for viewing through the display opening. The apparatus also has a camera on a flexible support, coupled to the computer display and configured to display video or images of the anatomical model.

### BRIEF DESCRIPTION OF THE DRAWINGS

FIG. 1A is a perspective view of one embodiment of a surgical training simulator in its stowed configuration.

FIG. 1B shows the simulator of FIG. 1A with an external support assembly released.

FIG. 1C illustrates an embodiment of legs which were stored beneath the external support assembly as attached to leg attachment points located at the four corners of the external support assembly.

FIG. 1D illustrates a main storage compartment of the simulator of FIG. 1A being set down on the external support assembly.

FIG. 1E shows a handle in an extended view and an accessory tray being set down upon the handle.

FIG. 1F illustrates a display latch coupled to a display latch receiver in an embodiment of the external support assembly.

FIG. 1G shows the main storage compartment with its lid latches released and the lid of the main storage compartment pivoted open.

FIG. 1H shows a platen being lifted out of the main storage compartment.

FIG. 1J illustrates an example of an accessory being placed into an embodiment of the accessory tray.

FIG. 1K is a view down into one embodiment of the main storage compartment while the platen is removed.

FIGS. 1L-1, 1L-2, and 1L-3 show an embodiment of the inner lid of the main storage compartment in three different configurations.

FIG. 1M illustrates the platen having been set back into the main storage compartment, this time flipped over so that an anatomical model is visible.

FIG. 1N illustrates, an embodiment of a camera positioned so that an image of a portion of the anatomical model is displayed on a computer display.

FIG. 2 illustrates an embodiment of a rail system for swapping an anatomical models.

FIG. 3 illustrates an embodiment of a simulator having operating room table clamp rails.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

A computerized training system was developed to simulate the “hands-on” surgical setting of a mini-thoracotomy AVR. This portable, comprehensive simulator incorporates video image acquisition and display, realistic plastic anatomic chest wall and cardiac tissue structures that can be dissected and sutured, along with retractors and other aids replicating representative surgical ergonomics. The surgeon uses manual and automated surgical devices to achieve various tasks, potentially including placement of cardioplegia catheters, aortotomy, leaflet removal, annular and sewing cuff suture placement, securing valve, closing aorta, etc. Plastic components can be readily replaced for repeat training activities.

This simulator successfully modeled a mini-thoracotomy AVR opportunity to hone skills toward improved surgical proficiency through the use of integrated computerized instructions, authentic tissue models and appropriate imaging. Annular sutures were placed through the right second intercostal space. Representative prosthetic valves were installed efficiently at the simulated aortic annulus and reliably secured with hand-tied knots or titanium fasteners. The trainees' learning experience mimicked the operating room setting, while they developed a more thorough understanding of a mini-thoracotomy AVR.

By providing realistic training, surgical simulators can be used to enhance surgical skills and improve technique knowledge without risk to the patient. This customized MI-AVR simulator training platform provides an elegant option to potentially reduce the learning curve for minimally invasive aortic valve replacement surgery and to accommodate busy cardiac surgeons. The platform can also be used for MI-MVR, MI-MV repair, and other minimally invasive cardiac surgical procedures.

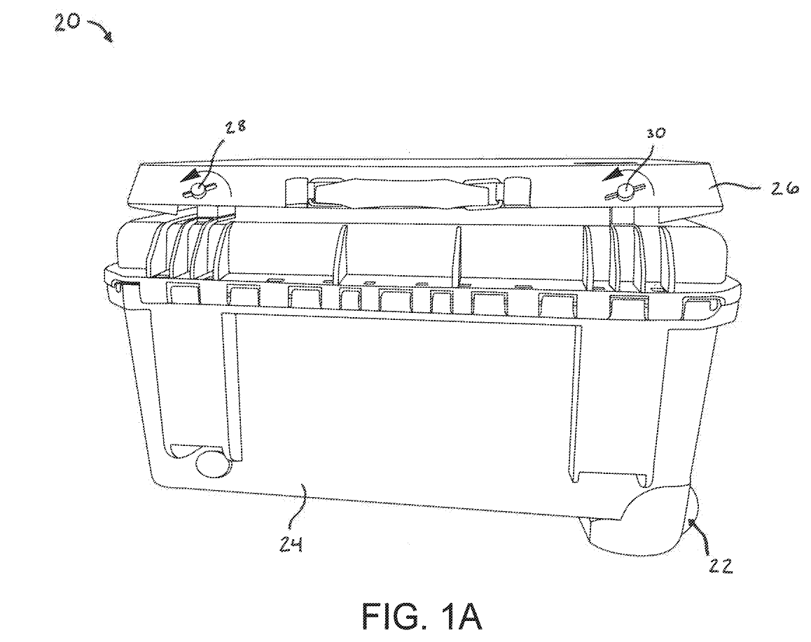

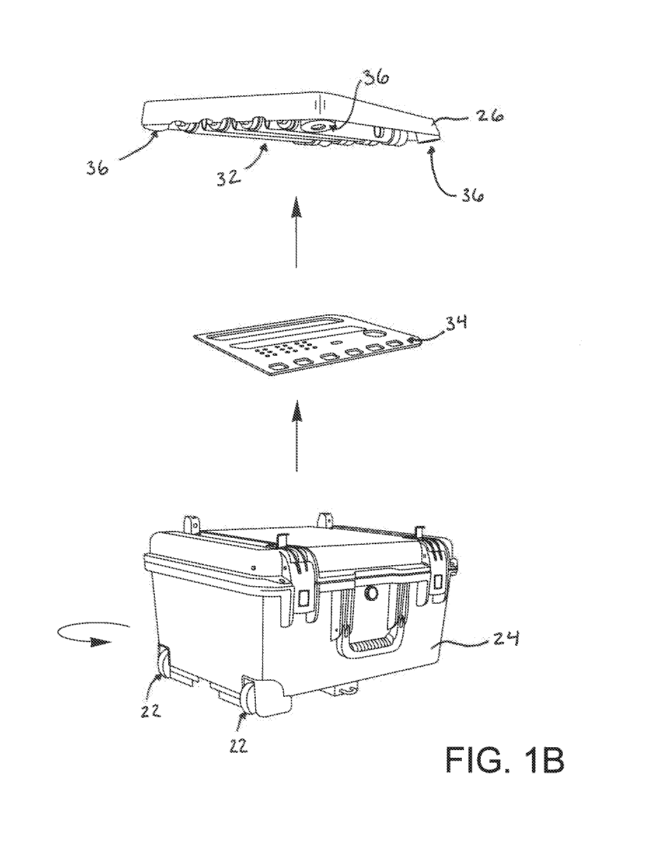

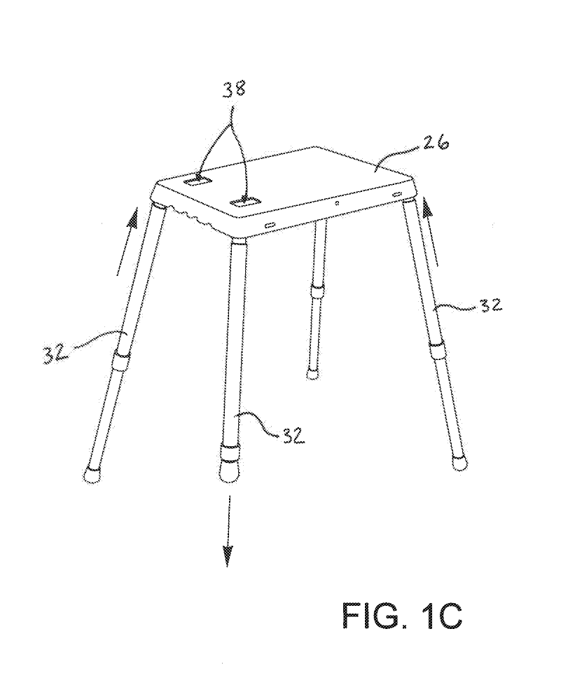

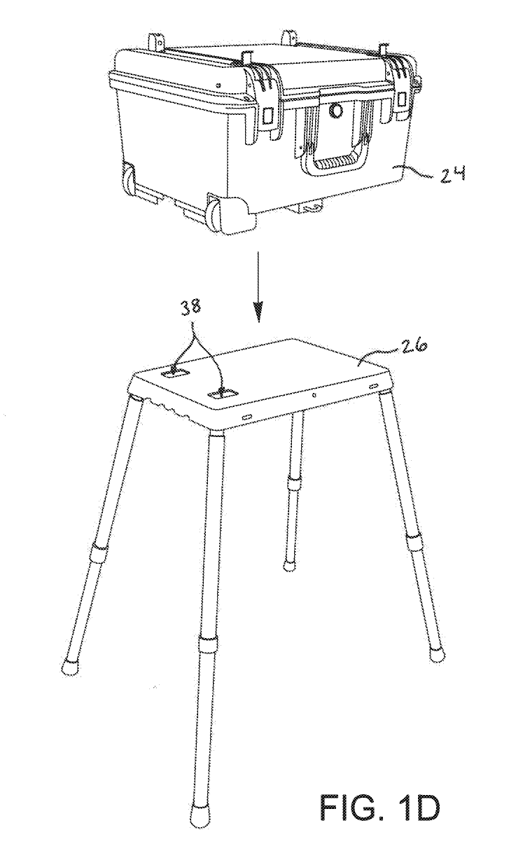

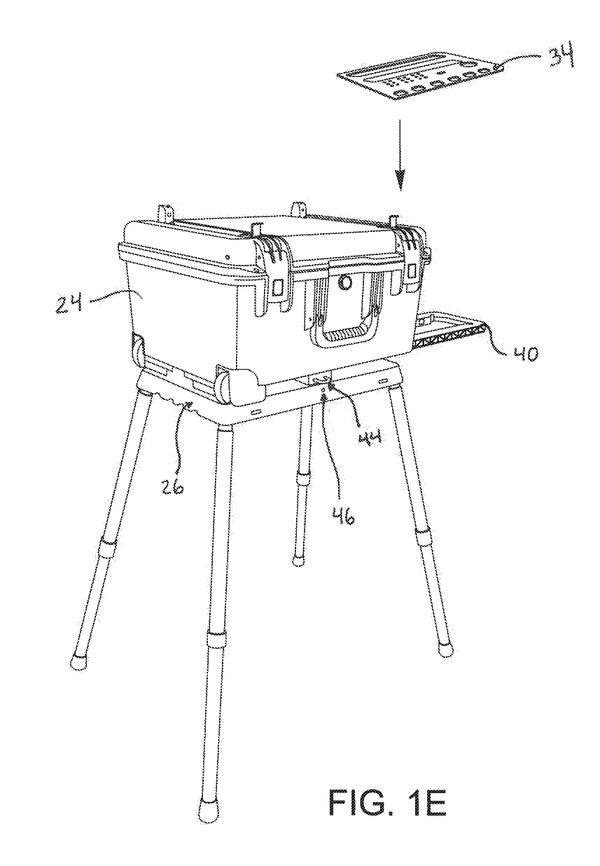

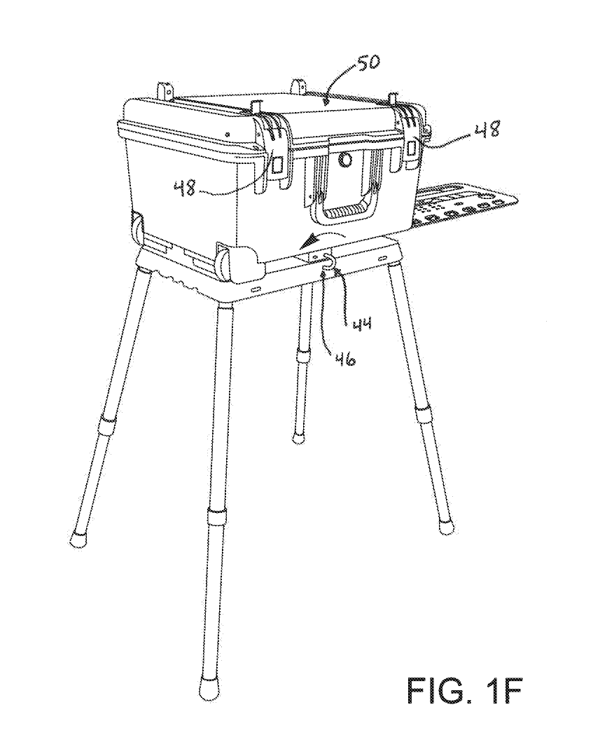

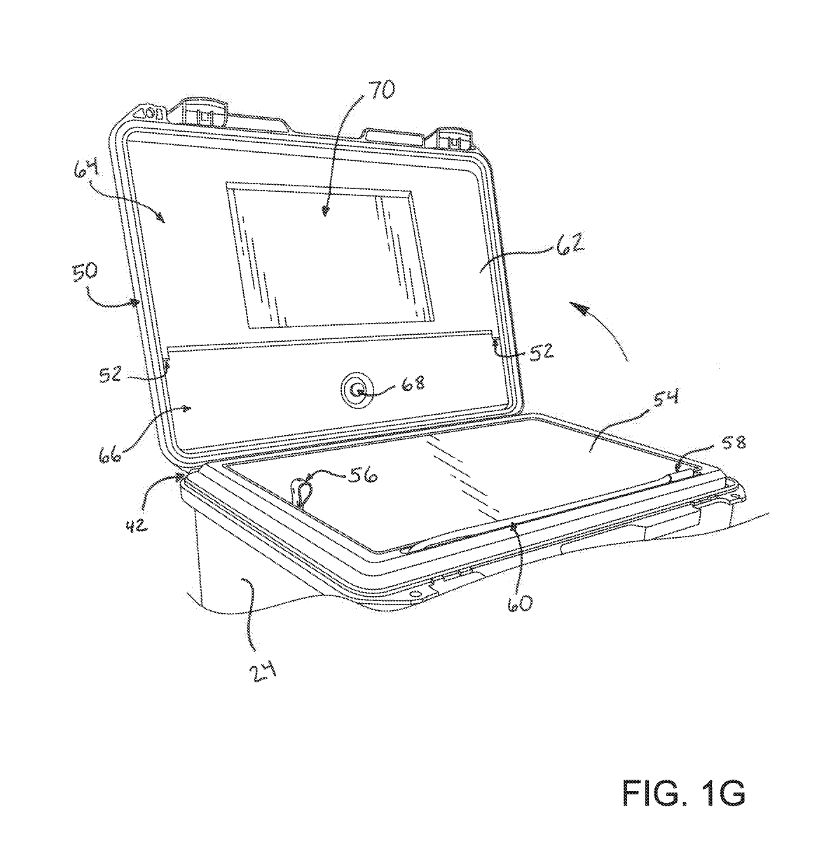

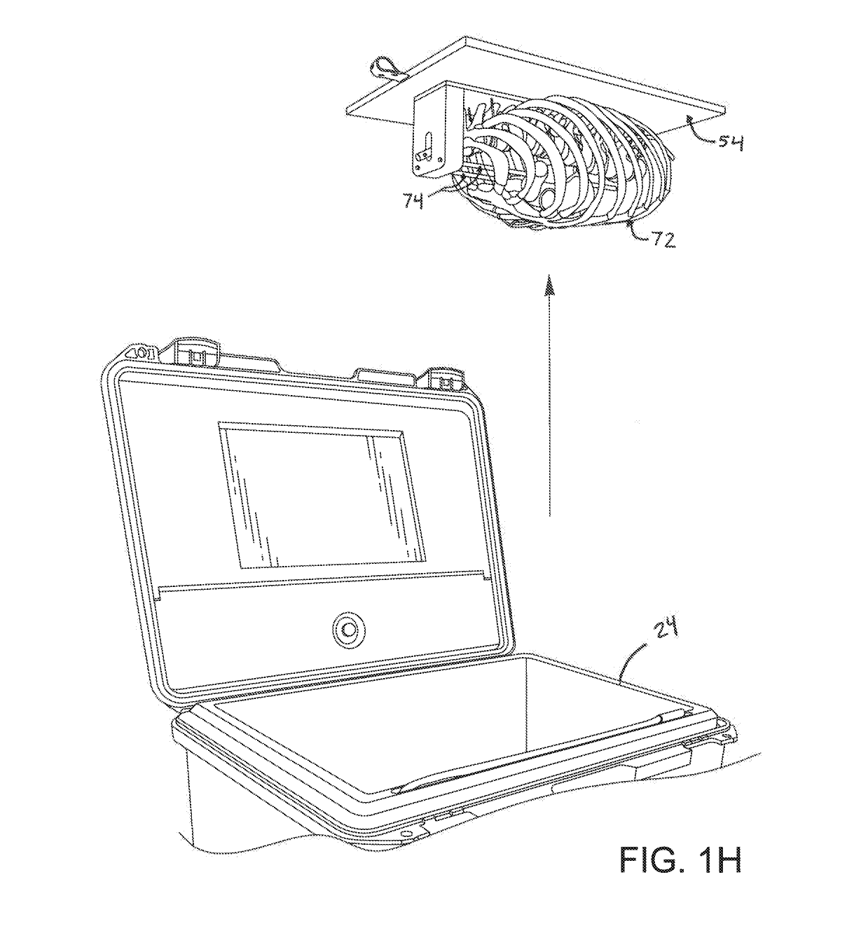

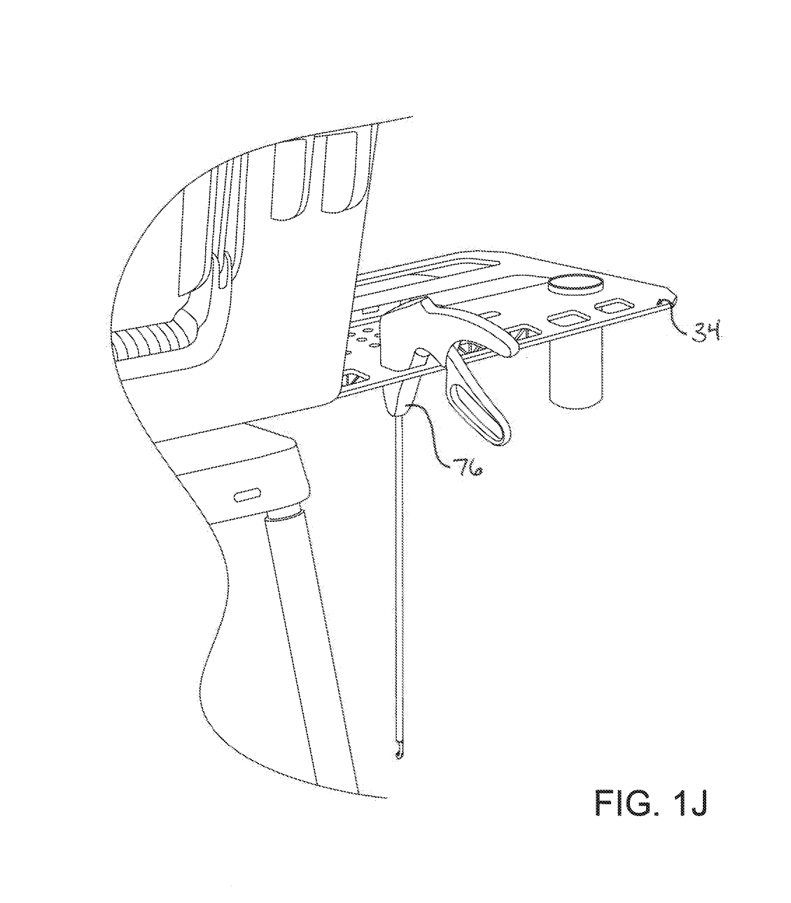

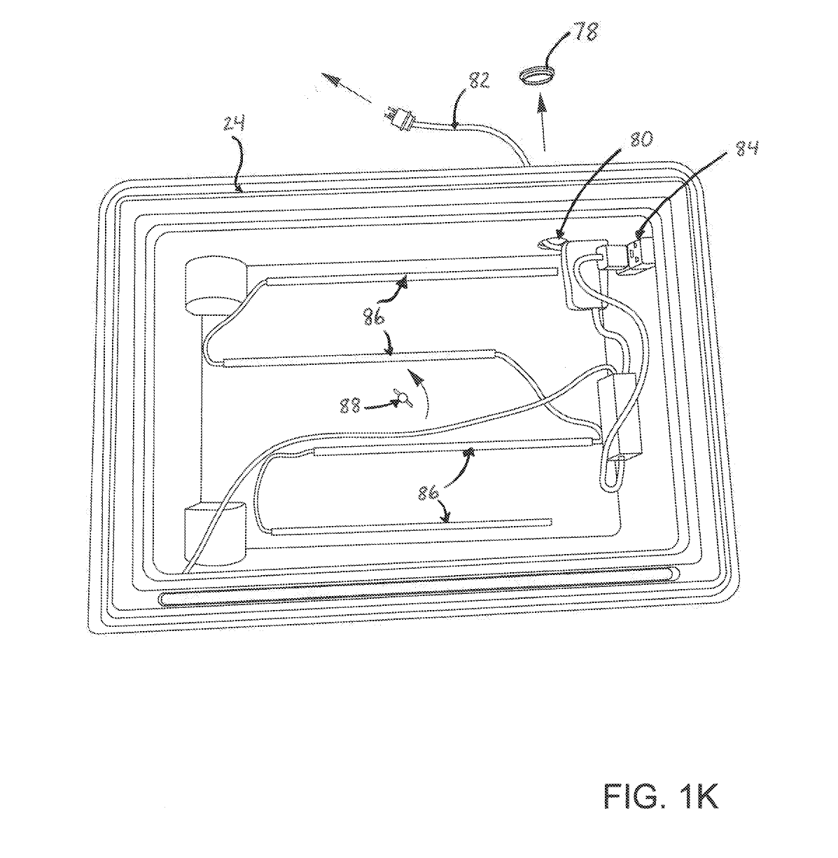

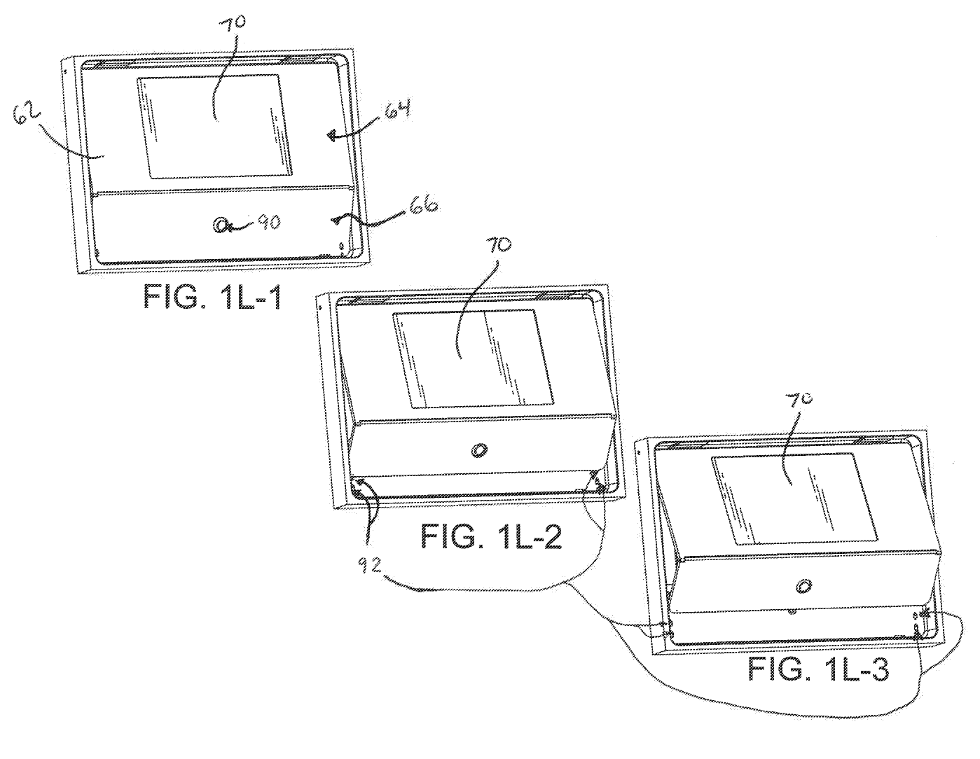

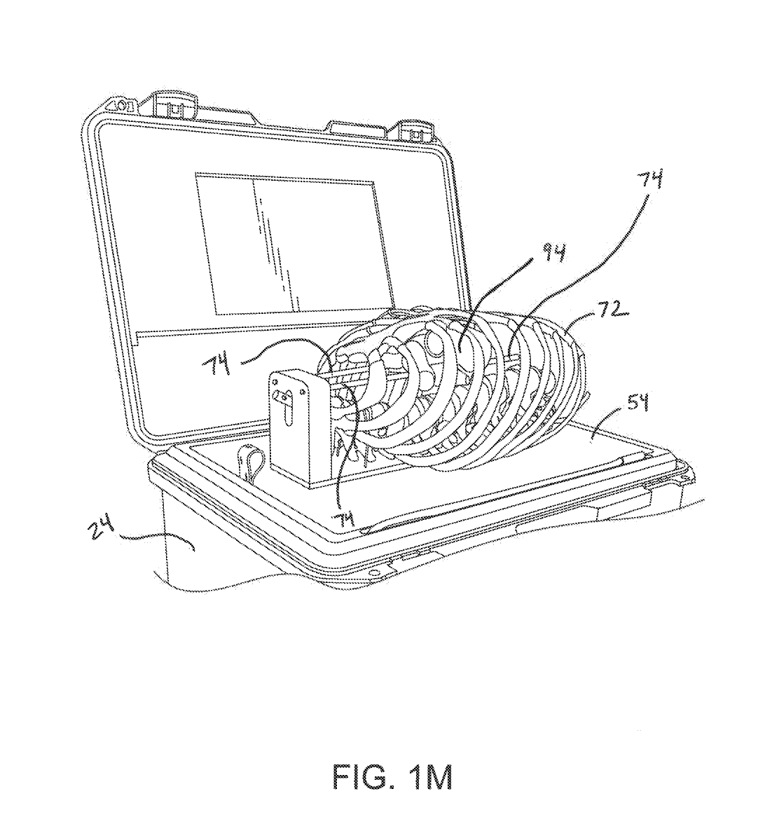

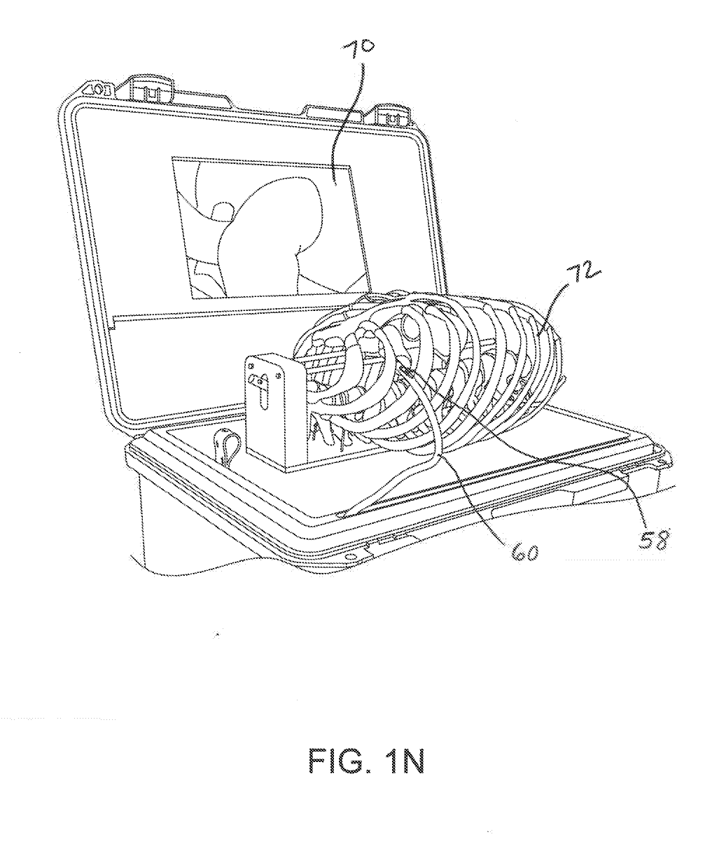

FIG. 1A is a perspective view of one embodiment of a surgical training simulator 20 in its stowed configuration. The training simulator 20 has wheels 22 and a handle 40 (not visible in this view) for pulling the stowed simulator 20 on the wheels 22. The simulator 20 has a main storage compartment 24 and an external support assembly 26. The view of FIG. 1A shows the back side of the main storage compartment 24. The external support assembly 26 is removably attached to the main storage compartment 24 when the simulator 20 is in the stowed configuration. One or more support stowing latches 28, 30 keep the external support assembly 26 attached to the main storage compartment 24. When it is desired to set up the simulator 20, the support latches 28, 30 may be turned to release external support assembly 26.

FIG. 1B shows the simulator 20 with the external support assembly 26 released. The view of FIG. 1B is from the front side of the simulator 20 (FIG. 1A was from the back side). The external support assembly 26 has four legs 32 which are stored beneath it which are now accessible. An accessory tray 34 may also advantageously be stored/held between the external support assembly 26 and the main storage compartment 24. As shown in FIG. 1B, when the external support assembly 26 is released, the accessory tray 34 may also be retrieved.

The legs 32 stored beneath the external support assembly 26 may be attached to leg attachment points 36 located at the four corners of the external support assembly 26 as illustrated in FIG. 1C. The legs 32 are advantageously telescoping and a desired height for the external support assembly 26 may be established.

The external support assembly 26 may have one or more location feature receivers 38 which can accept corresponding location features on the bottom of the main storage compartment 24. As illustrated in FIG. 1D, the main storage compartment 24 may be set down on the external support assembly 26. If there are locating features on the main storage compartment 24, they should be aligned with the corresponding location feature receivers 38 in the top of the external support assembly 26.

Previously, the main storage compartment 24 was referred to as having a handle 40 which could be used to pull the stowed simulator 20 on the simulator's wheels 22. The handle 40 is shown extended in FIG. 1E. In this view, the handle 40 is not being used for movement, but rather, has been extended to one side of the main storage compartment 24 as an accessory tray 34 support. As shown in FIG. 1E, the accessory tray 34 may be set down upon the handle 40. The accessory tray 34 may have one or more locating features which interact with corresponding features on the handle 40 to help keep the accessory tray 34 from moving.

It is also helpful to note a display latch 44 and a display latch receiver 46 in FIG. 1E. The display latch 44 is coupled to the main storage compartment 24. The display latch receiver 46 is formed in the external support assembly 26. The display latch 44 is biased towards the main storage compartment 24, but it may be pulled out, pivoted and then latched into the display latch receiver 46 in the external support assembly 26 as illustrated in FIG. 1F.

The main storage compartment 24 has one or more lid latches 48 which may be released so that the lid 50 of the main storage compartment 24 can be pivoted open on its hinge 42 as shown in FIG. 1G. A removable platen 54 is supported inside the main storage compartment 24. As shown in FIG. 1G, we're actually looking at the bottom side of the platen 54 while it is in its stowed position. A platen removal feature 56 is available for grabbing the platen 54 and lifting it out of the compartment 24. In the illustrated embodiment, the platen removal feature 56 is a tab coupled to the platen 54. In other embodiments, the platen removal feature 56 may be a ribbon connected to the main storage compartment 24 that helps to lift the platen 54 up. In still other embodiments, the platen removal feature 56 may be a notch or hole in the platen 54 or a handle. The platen 54 may be made from a variety of materials, but preferably, the platen 54 is translucent and able to be back lit in a way that allows the platen 54 to glow uniformly without being able to identify the positions of the individual backlights.

The main storage compartment 24 also houses an endoscopic camera 58 on a flexible support 60. A hinged lid liner 62 is located inside the lid 50 of the main storage compartment 24. As shown in FIG. 1G, the hinged lid liner 62 has two facets 64, 66 which are coupled together by one or more hinges 52. The top, backside of the first facet 64 is also coupled to the top inside of the lid 50. As shown in FIG. 1G, the first and second facets 64, 66 are lying in substantially the same plane. The second facet 66 is locked into the inside of the lid 50 with a thumbscrew 68. A computer display 70, preferably as part of a computer tablet is mounted behind the first facet 64 and viewable through an opening in the first facet 64. If the computer display 70 is also a touch-screen, the computer coupled to the screen may be programmed to display product information, procedure information, training videos, training slides, and/or training illustrations. The computer display 70 could also be used to gather information about someone who is using the simulator 20. The endoscopic camera 58 is preferably coupled to the computer, so live video images from the camera 58 may also be displayed on the computer display 70.

As shown in FIG. 1H, the platen 54 may be lifted out of the main storage compartment 24. The top side of the platen 54 is facing down when the platen 54 is stored, and as shown in FIG. 1H, the platen 54's top side (facing downward here) has a rib cage 72 which is mounted to the platen 54. A rail system 74 extends through the rib cage 72 and will be discussed in more detail later. The platen 54 may be turned right-side up, but should be held out of the main storage compartment 24 for a moment.

Underneath the platen 54 and ribcage 72 which were stored in the main storage compartment 24, there is room for surgical accessories, such as, but not limited to a minimally invasive surgical suturing device 76. These accessories may be placed into the accessory tray 34 as illustrated in FIG. 1J.

FIG. 1K is a view down into the main storage compartment 24 with the platen 54 removed. For convenience, the lid 50, accessory tray 34, and legs 32 are not shown in this view. An access plug 78 may be removed from an access hole 80 in the back side of the main storage compartment 24. One or more power cords 82 may be passed out of the access hole 80 so that they can be plugged in to a power source. While some embodiments could have a battery for power and not need a plug, some embodiments may find having a power cord 82 desirable. The main compartment 24 may be outfitted with one or more plug strips 84, as there may be one or more devices which need power, such as, but not limited to the computer/computer display 70, the camera 58, and the light source 86 which is located in the bottom of the main storage compartment 24. The main storage compartment 24 may also have a further attachment latch 88 for coupling the main storage compartment 24 to the external support assembly 26.

FIGS. 1L-1, 1L-2, and 1L-3 show the inside of the lid 50 of main storage compartment 24. For convenience, the rest of the simulator 20 is not shown in these views. The thumbscrew 90 which holds the second facet 66 of the hinged lid liner 62 to the lid 50 may be unscrewed from the lid 50. When the thumbscrew 90 is detached from the lid 50, the second facet 66 is free to pivot with respect to the first facet 64. The lower backside of the second facet 66 has feet which can rest in facet foot receivers 92, allowing the angle between the first and second facets 64, 66 to be varied as desired. This alters the viewing angle of the computer display 70 for user preference and comfort.

The platen 54 may be set back into the main storage compartment 24, this time right side (rib side) up, as shown in FIG. 1M in a display position. An anatomical model 94 is mounted on the rail system 74 and is visible through the ribcage 72. The anatomical model 94 may be chosen and configured for one or more particular surgical procedures. For example, the anatomical model 94 could be a heart for aortic valve replacement, mitral valve replacement, mitral valve repair, or coronary artery bypass.

As illustrated in FIG. 1N, the camera 58 may be positioned between the ribs 72 and the computer display 70 turned on so that the camera 58 images are displayed on screen 70. This simulates a percuscopic surgical procedure whereby an endoscopic camera 58 is used to provide imagery to help guide a minimally invasive surgical procedure.

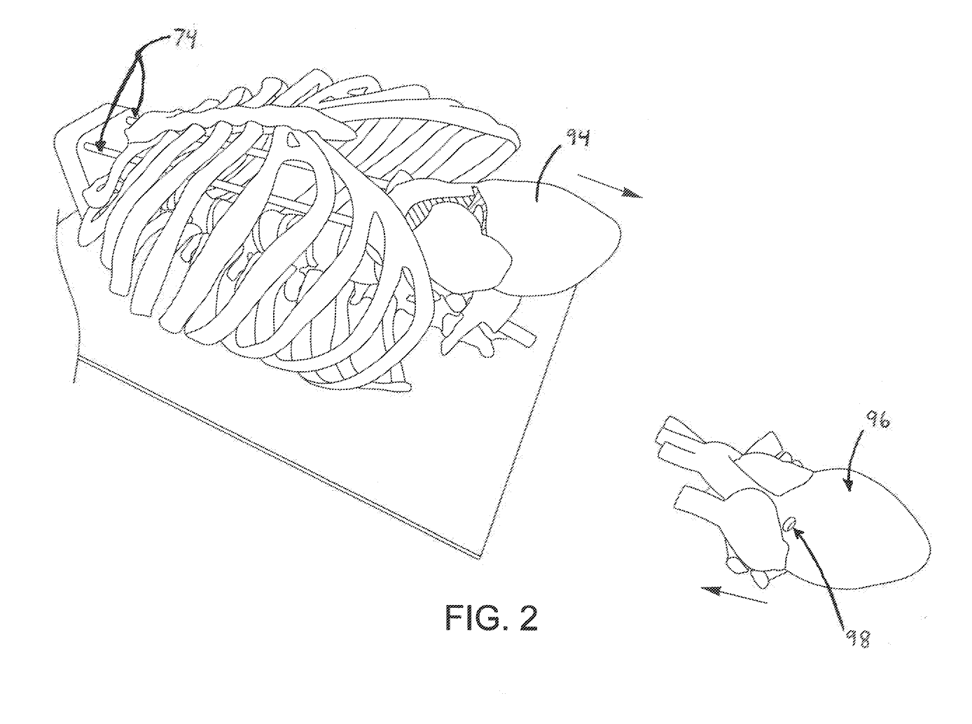

FIG. 2 illustrates the rail system 74 while swapping a second anatomical model 96 for a first anatomical model 94. Each anatomical model 94, 96 has corresponding channels 98 to ride the rails 74 of the rail system. The fit of the channels 98 relative to the rails 74 may be configured to provide friction which will hold the anatomical model in place. Alternatively, a means for holding the anatomical model in place on the rails 74, such as but not limited to a set screw, may be used.

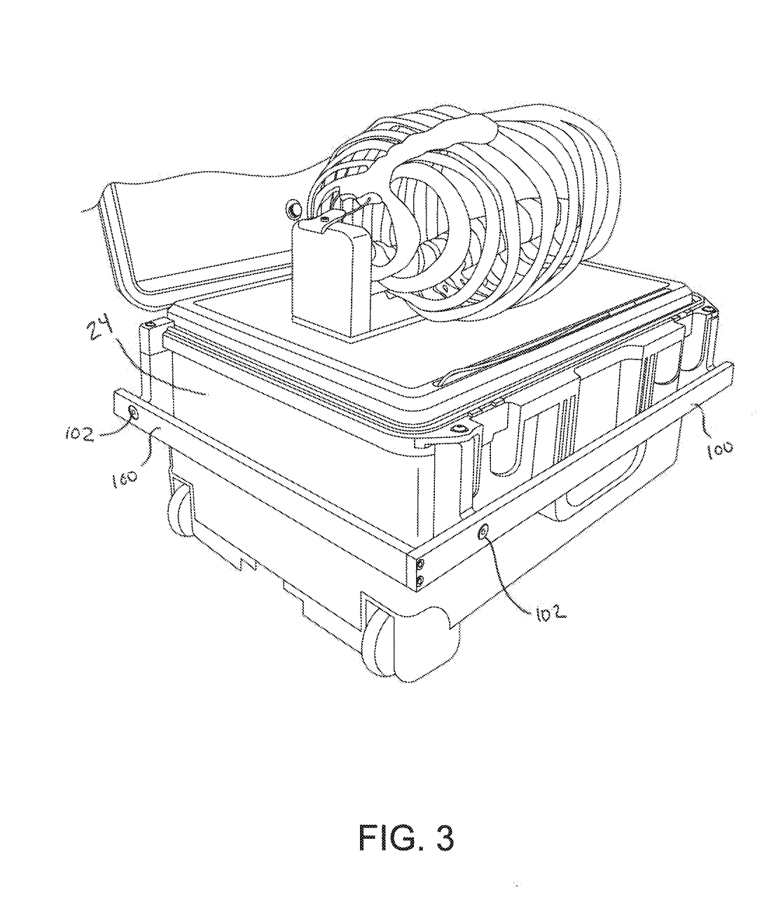

FIG. 3 illustrates an embodiment of a simulator having operating room table clamp rails 100 attached to the outside of the main compartment 24 by one or more screws 102. Such table clamp rails 102 may be used as mounting points for surgical accessories and may enable such types of surgical accessories to be demonstrated and used in surgical simulations.

Various advantages of an apparatus for minimally invasive percuscopic surgical simulation have been discussed above. Embodiments discussed herein have been described by way of example in this specification. It will be apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. The drawings included herein are not necessarily drawn to scale. Additionally, the recited order of processing elements or sequences, or the use of numbers, letters, or other designations therefore, is not intended to limit the claims to any order, except as may be specified in the claims. Accordingly, the invention is limited only by the following claims and equivalents thereto.

What is claimed is:

1. An apparatus for surgical simulation, comprising:
a main storage compartment having a pivoting lid, a lid liner defining a display opening, and a light source;
an external support assembly removably coupled to the main storage compartment in a stowed configuration and further configured to provide a support structure for the main storage compartment in an unstowed configuration;
a removable platen configured to be held by the main storage compartment in either a stowed position or a display position;
a ribcage coupled to the removable platen;
a rail system for holding an anatomical model within the rib cage;
a computer display for viewing through the display opening; and
a camera on a flexible support, coupled to the computer display and configured to display video or images of the anatomical model.
